(19) United States
(12) Patent Application Publication
(10) Pub. No.: US 2013/0218534 A1
(43) Pub. Date: Aug. 22, 2013

(54) ADHESIVE CURE MONITOR

(71) Applicant: David John Hill, Ann Arbor, MI (US)

(72) Inventor: David John Hill, Ann Arbor, MI (US)

(73) Assignee: FORD GLOBAL TECHNOLOGIES, LLC, DEARBORN, MI (US)

(21) Appl. No.: 13/397,699

(22) Filed: Feb. 16, 2012

(51) Int. Cl. G06F 17/10

(52) U.S. Cl. 703/2

(57) ABSTRACT

A device for monitoring the extent of cure of an adhesive located between at least two components. The device includes a data logger operably connected to at least one of the components, and configured to record data related to time and temperature, obtaining a thermal history data of the component during a heating process. An algorithm, installed in the data logger, processes the thermal history data of the component. A kinetic cure model is included in the algorithm calculating and predicting an extent of adhesive cure according to the processed thermal history. The device further includes a visual display operably connected to the data logger and configured to indicate the extent of adhesive cure.

### BACKGROUND

This application generally relates to the field of curing adhesives applied in bonding of sheet component materials, and, more particularly, relates to monitoring the extent of an adhesive cure.

Adhesives used in sheet component bonding, especially sheet metal bonding, find wide applications in modern industrial practices. Sufficient curing of the sheet metal bond for a product, over a certain range of temperatures and time, however is required but can be difficult to verify. Sufficient curing allows the product to realize its mechanical properties. Certain sheet metal structures having complex configurations, can create difficulties in assumptions and calculations, performed to confirm a complete cure of an applied adhesive bond within a component.

To this end, a temperature profiling system, such as one available from Datapaq Ltd., is applied in some traditional practices. Datapaq systems enable a data logger, including temperature sensors, to be connected to component, or a component region, during the component's travel through a bake oven. Time and temperature data registered into the Datapaq device is later downloaded and plotted in relation to each other to obtain a thermal history of the component. This process is, however, time consuming and does not provide immediate information about the extent of cure within the adhesive. Further, conventional data loggers, being large in dimensions and size, are bulky and inconvenient for regular usage.

It would thus be beneficial to have a system that could be made portable, and that provides more immediate details related to the extent to which an applied adhesive bond has cured within a component, enabling effective tests and inspections to be carried out in a more timely and efficient fashion.

### SUMMARY

One embodiment of the present disclosure describes a device for monitoring the extent of cure of an adhesive located between at least two components. The device includes a data logger operably connected to at least one of the said components, and configured to record data related to time and temperature, obtaining a corresponding thermal history data of the component during a heating process. The device further includes an algorithm installed in the data logger to process the thermal history data of the component. The algorithm includes a kinetic cure model that calculates and predicts an extent of adhesive cure according to the processed thermal history. A visual display, operably connected to the data logger, is configured to indicate an extent of adhesive cure.

Another embodiment of the present disclosure describes a device for monitoring adhesive cures between at least two sheet metal components. The device includes a c-clamp for clamping onto at least one of the sheet metal components, and further configured to include a temperature probe to read the sheet metal component's surface temperatures. A data logger, connected to the temperature probe, is configured to record data related to the temperature and time, and to obtain a corresponding thermal history data of the sheet metal component during a heating process. The data logger includes an algorithm to process the thermal history data of the sheet metal component, the algorithm including a kinetic cure model to calculate and predict an extent of adhesive cure according to the processed thermal history. A light emitting diode, operably connected to the data logger, is configured to indicate the extent of adhesive cure, and, more particularly, whether a sufficient cure has been achieved. Further, the device is configured with a thermal insulation layer to protect the device from high temperatures during the heating process. In addition, the thermal insulation layer includes a quartz glass rod that provides visibility to the light emitting diode through the thermal insulation layer.

Certain embodiments of the present disclosure describe a device to monitor cure in adhesives applied between at least two sheet metal components. The device includes a clamp, configured to clamp the device onto at least one of the sheet metal components, a data logger, configured to record data related to the temperature and time, and to obtain a corresponding thermal history data of the sheet metal component to which the device is clamped on to. The data logger includes an algorithm to process the thermal history data of the sheet metal component, the algorithm including a kinetic cure model to calculate and predict an extent of adhesive cure according to the processed thermal history during a heating process. A light emitting diode operably connected to the data logger is configured to indicate the extent of adhesive cure, and a thermal insulation layer is provided to protect the device from high temperatures during the heating process.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic of an adhesive cure monitor device attached to two sheet metal components, with an adhesive between the components, according to the present disclosure.

FIG. 2 is a schematic representation of the device attached to two sheet metal components, with an insulating layer around the device.

FIG. 3 is a graph plotting relationship curves, depicting a thermal history of the sheet metal components during a heating process, and cure curves of two adhesives, all obtained through the cure monitor device, according to the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes methods and systems for monitoring cure in adhesives applied generally in sheet components, and especially sheet metal components, such as those employed in automobile manufacturing. To this end, a portable device is configured to be clamped onto a region on a sheet metal component, while the component undergoes a heating process. Once clamped, a data logger configured within the portable device is adapted to log and record temperature and time related data, enabling the establishment of a thermal history of the component. Thermal history data thus obtained is configured to be processed through an algorithm installed in the data logger. Further, an extent of cure, calculated and predicted through a kinetic cure model, configured within the algorithm, is eventually displayed through a visual display disposed on the portable device to be eventually seen by a user.

### EXEMPLARY EMBODIMENTS

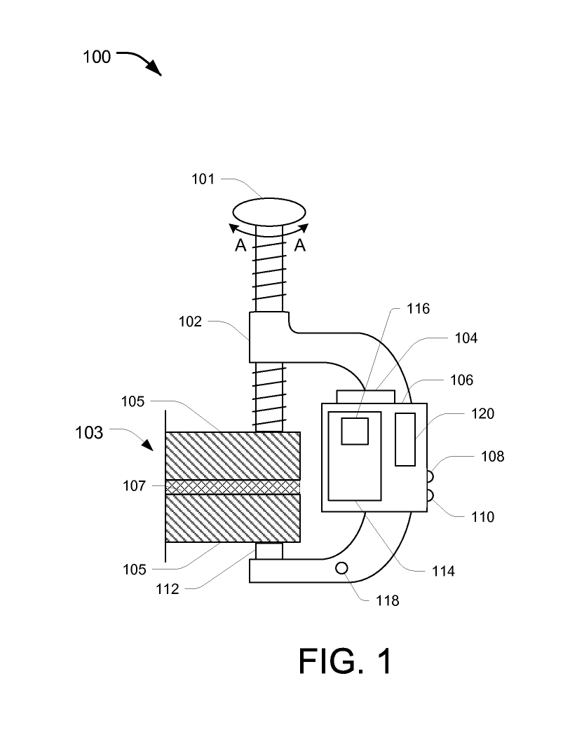

FIG. 1 illustrates an exemplary cure-monitoring device, referred to as a data logging device 100, configured to be compact and portable, allowing the device 100 to be carried around with ease. The device 100 primarily includes a c-clamp 102, which enables the device's attachment onto a desired region of a component assembly 103, and a data logger 106, to log and record temperature values. Particularly, the device 100 has a visual display comprising light emitting diodes, referred to as a red LED 108, and a green LED 110. The device 100 further includes a long-life battery 104 that acts as a source of power for the data logger 106 and the visual display. A memory 116 that stores contents related to data logging device 100 is configured within a controller 114. More so, a timer 120 keeps track of time, and a switch 118 disposed on the c-clamp 102 enables a manual activation and deactivation of the data logging device 100.

The component assembly 103 comprises two sheet components 105 with a layer of adhesive 107 between the components. More particularly, the sheet components 105 are made of sheet metal, and form part of the structure of an automobile, for example a door flange (not shown). In other embodiments, the sheet components can be formed of other materials, such as fiberglass.

The c-clamp 102 is lightweight, and is sized and designed to be held by a human hand, the shape being similar to conventional c-clamp designs. To keep the device 100 light in weight, a plastic material, configured to be chemically stable, and capable of withstanding high temperatures, is preferably used. As an example, Glass Reinforced Polyphenylsulfone is one class of plastic that is observed to have a high melting point. Further, the material being resistant to a variety of chemicals proves beneficial in an environment comprised of electro-coats, paints, and other similar sheet metal coating agents. In addition, the c-clamp 102 comprises a knob 101 that allows a rotary tightening and loosening feature to the c-clamp 102, depicted through the arrow A, and configured to aid in accommodating the component assembly 103 within the c-clamp 102, as shown, through the tightening feature. Particularly, the c-clamp 102 enables the data logger 106 to be operably connected to the component assembly 103.

Alternatives and variations to the c-clamp 102 can include different configurations, designs and shapes to the one described according to the present disclosure. More particularly, any means for attaching the device to a particular region on a component can be used, and a person ordinarily skilled in the art is capable of knowing and developing such means.

As part of the device 100, a temperature sensor, referred to as a temperature probe 112, is a part of the c-clamp 102, and is accordingly disposed on the c-clamp 102, as shown in FIG. 1. The probe 112 is configured to read temperature of a particular region or a surface of a component that it maintains contact with, while the c-clamp 102 clamps to a region on the component assembly 103. In addition to the temperature probe 112, the timer 120, configured to track time, is disposed on the c-clamp 102, as shown. Both the temperature probe 112 and the timer 120 are either configured to be integral to the data logger 106, or connected to the data logger 106 through cabling means.

The temperature probes and timers, such as the ones discussed above, are conventionally used devices, widely known and applied by the ones skilled in the art, and thus will not be discussed further.

Data logger 106, through the temperature probe 112 and the timer 120, records temperature and time related data in the memory 116, disposed within the controller 114 in the data logger 106. A thermal history is thus enabled and configured to be stored within the memory 116.

One part of the hardware of the data logging device 100 includes a controller 114 disposed within the data logger 106. As is known, the controller 114 is a microprocessor based device that includes a CPU, enabled to process the incoming information from a known source. Further, the controller 114 may be incorporated with volatile memory units such as a RAM and/or ROM that functions along with associated input and output buses. The controller 114 may also be optionally configured as an application specific integrated circuit, or may be formed through other logic devices that are well known to the skilled in the art. More particularly, the controller 114 may either be formed as a portion of an externally applied electronic control unit, or may be configured as a stand-alone entity.

The memory 116, disposed within the controller 114, may be a non-volatile storage medium that stores information related to the overall functioning of the device 100. The memory 116 may thus particularly record information related to the sensed surface temperature and tracked time. Further, the memory 116 may also be configured to include predetermined clamp tensioning values, maximum and minimum workable temperature values for the device 100, maximum and minimum battery life, life cycles, time and temperature conversions and scales, compatible algorithms to plot the time above a temperature, specifications of the data logger 106, memory 116, controller 114, the c-clamp 102, etc. More particularly, the memory 116 is configured to store specific material characteristics as well, that require implementation during an application of the device 100. Such materials, primarily being the applied adhesives, like the adhesive 107, have specific properties like the specific cure rates according to a varying time and temperature pattern, and all such rates and other related information are also configured to be installed in the memory 116.

It is understood that the data logger 106 applied in the present disclosure is similar to the conventionally applied Datapaq systems on shop-floors for logging data related to the time and temperature of a particular region of a sheet metal component. Other configurations and designs of such devices are known to those skilled in the art and thus will not be discussed further.

One of the primary aspects of the present disclosure lies in installing and storing an integration algorithm within the data logger 106 in the memory 116. The integration algorithm forms the foundation to convert the sensed and recorded time and temperature values into a compatible format and process them. Configured along reaction kinetics, the integration algorithm further includes a kinetic cure model adapted to calculate and predict an extent of cure in an applied adhesive material, such as the adhesive 107, according to the processed thermal history. The kinetic cure model, as noted, may be expressed according to the following relation, termed as equation 1:

dX/dt=Ae^{-Ea/RT}·X^{m}·(1−X)ⁿ

### Where,

X=fractional conversion (degree of cure)
dX/dt=reaction rate (min⁻¹)
m, n=reaction orders
T=temperature (K)
R=universal gas constant (8.23 J/mol.K)
A=pre-exponential factor (min⁻¹)
Eₐ=activation energy (J/mol)

For every adhesive, the four material parameters m, n, A and Eₐ are determined off-line using a Differential Scanning calorimeter (DSC). Equation 1 is then employed to calculate the amount of cure for each time and temperature step. These discrete values are then accumulated to determine the degree of cure at a specific time.

Reaction kinetics predicts an extent of cure, as stated above, particularly utilizing the information stored within the memory 116 regarding how the cure rates of different adhesive materials vary according to a factor of time and temperature. Completion of an adequate cure is then conveyed to an operator of the device, as further explained below.

Accordingly, the red LED 108 and the green LED 110 are either integral or physically and operably connected to the controller 114, disposed within the data logger 106, via cables. The LEDs 108 and 110 are configured to emit their lights in response to an output provided by the controller 114. These outputs may enable the LEDs 108 and 110 to emit light in certain patterns, for example, a constant pattern, blinking pattern, etc., all such patterns indicating the extent of curing of an applied adhesive, such as the adhesive 107. In the illustrated embodiment, a red light indicates an inadequate cure, while a green light indicates an adequate cure. In an alternate embodiment (not shown), the visual display enabled through the LEDs 108 and 110 may be configured as a digital display, depicting numerical or percentage based values intended for better user perception. Alternatively, the unit could also vibrate or sound an alarm to provide an increased level of warning or for use in environments where an LED or a visual display cannot easily be seen.

As a source of power, the battery 104 is included in the data logging device 100, and is accordingly a rechargeable and a replaceable long-life lithium chloride battery.

The switch 118 could be a button or a knob, ergonomically designed, as would be known to a person skilled in the art. An alternative to the switch 118, as disclosed, could be a tilt sensor or an accelerometer (not shown), that allows the data logging device 100 to be deactivated when held stably in an inverted position. In another embodiment, the device 100 could be configured to remain active at all times, but could be reset to a “zero time” by shaking the device 100 a couple of times. Such shaking would also require the employment of an accelerometer within the device 100, the shaking being based upon a movement of the device 100 in a manner other than what the device 100 would typically experience during regular operations.

The device 100, and it's layout set out above, operates to assist in improving efficiency in conventional shop-floor practices that includes the passage of an assembly of sheet metal components (at least two sheet metal components), glued together with an industrial adhesive, such as the adhesive 107, through an electro-coat bake oven. Device 100, accordingly, operates as follows.

As is currently known, the passage of an assembly of sheet metal components through an electro-coat oven primarily functions to crosslink and cure a paint/coat/film applied on the sheet metal components, making the paint/coat/film hard and durable to assure maximum performance properties. The oven's operational temperatures can range from 20° C. to 210° C., being largely dependent on the paint/coating technology being used and the time the assembly travels in the oven. Most often, maintaining the assembly for 10-20 minutes at a recommended temperature ranging from 170° C.-190° C. is considered to obtain full cure for a recommended set of adhesives, such as the adhesive 107, applied within the component assembly 103. However, such is not always the case.

In operation, the device 100 is activated through the switch 118 and clamps on to a sheet metal component, through the c-clamp 102, over a particular region that includes the applied adhesive 107, which needs to be monitored. While passing through the electro-coat bake oven, the device 100, logs and records temperature and time related data, of the particular region, via the probe 112 and timer 120, respectively. The memory 116 configured within the data logger 106, stores and records this data, to be further processed through the controller 114. The integration algorithm, configured within the controller 114, processes this obtained data via the kinetic model, as already discussed. Such processing brings about an output configured to be communicated to the visual display, externally and visibly disposed on the data logging device 100. The controller 114 delivers such output to the LEDs 108 and 110. Therefore, constant monitoring, displaying the state of the adhesive 107, and predicting the extent of cure of the adhesive 107, is enabled through the LEDs 108 and 110, included in the visual display, the LEDs 108 and 110 subsequently confirming the status of the applied adhesive 107 by responding to an output from the controller 114. A flashing or blinking green light through the green LED 110 indicates a progressive cure of the adhesive 107, while a constant emission of green light indicates a complete cure (at least 95% adhesive cure), and a constant red light emitted through the red LED 108 would indicate an incomplete cure. In an embodiment, limits could be set on the maximum time, or provisions for a response could be set, once the temperatures drops below a certain level indicating an end of cure or an end of a bake cycle.

Alternatively, as stated earlier, the visual display may be a digital display that may depict numerical values to make the user of the device 100 monitor and perceive the extent of cure of the adhesive 107 in a better manner.

Once the visual display confirms at least 95% cure, the device 100 can be removed, cooled, and then reused. Such cooling can be performed under refrigeration, or simply by placing the device 100 under ambient temperatures for a particular period according to an adopted shop-floor practice.

In an embodiment, the device 100 could determine a stable temperature condition by monitoring the internal temperature of the Printed Circuit Board (PCB), either through the temperature probe 112 itself, or through a secondary temperature sensor disposed within the device 100.

The aspects of the present disclosure could also be used to help set up an oven to ensure adequate cure either through trial and error, or through downloading the thermal history and kinetic cure data and running oven simulations to optimize a predicted cure. Once these oven parameters are established, the data logging device 100 could be used in regular modes to verify whether an adequate adhesive cure is obtained.

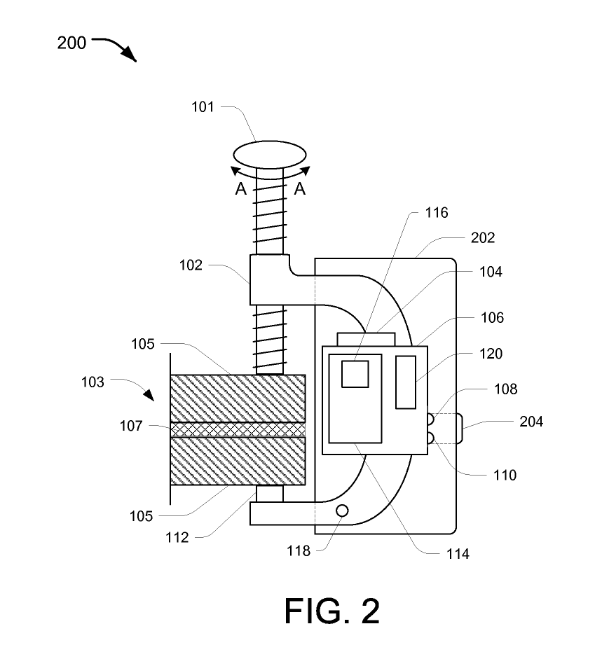

As shown in FIG. 2, the data logging device 100 further includes a thermal insulation layer 202, shown through an application 200, to enclose and protect the data logger 106, from the bake oven's extreme temperatures. With the insulation layer 202 in place, however, the visual display could be blocked from viewing. Such a condition is resolved through a quartz glass rod 204, which is made to pass through the insulation layer, enabling the LEDs 108 and 110 to emit light and be visible to a user on the exterior of the device 100. The quartz glass rod 204 consequently provides visibility to the visual display through the thermal insulation layer 202. Silicone foam, fiberglass, and certain polymer composites, can be the possible materials used to manufacture the insulation layer 202 as disclosed. More particularly, the materials recommended and useable for the insulation layer 202 are well known to those skilled in the art. In an embodiment, the thermal insulation layer 202 could include a phase change material (PCM), that have the ability to absorb a large amount of heat energy based on their latent heat. Such materials are reversible, giving up this stored energy as heat upon a cool down, and eventually returning to their original phase.

As is known in current practices, in a body paint process, for an assembly of sheet metal components, the passage of the assembly through an oven causes a completely cured paint/coat. The paint shop engineers and mechanics, however, are focused more towards the quality of paint/coat, and getting the paint cured as quickly as possible. Since the focus of the oven is more towards paint curing, and not adhesive curing, the extent of an adhesive's cure may be inadequate. The thermal history thus obtained enables the designers and the engineers to predictably attain a state of an adhesive applied within the assembly through the integration algorithm, all configured into the single portable data logging device 100.

The data logging device 100, being portable and compact in dimensions, not only allows easier accommodation into the assembly of the sheet metal components, but also enables the prediction of an extent of cure of adhesives applied to be readily observable to the bake oven operators.

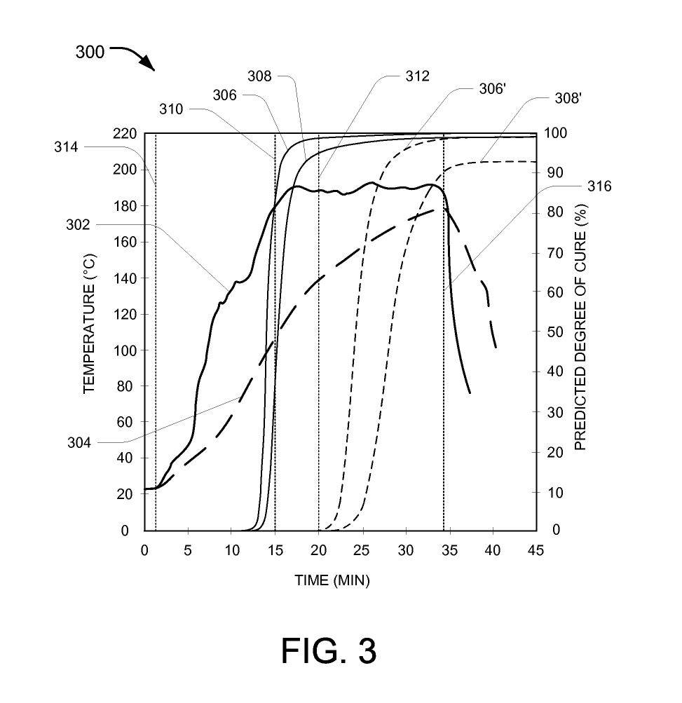

A graphical representation 300 of the thermal history, logged in by the data logging device 100, is depicted in FIG. 3, and illustrates a bake cycle within a bake oven through a set of curves and lines. The Y-axis, disposed on the left hand side, depicts temperature of the bake oven, in Celsius (° C.), whereas the Y-axis configured on the right hand side depicts the predicted degree of adhesive cure, in percentage (%). The X-axis depicts time in minutes (min). Thermal history of a sheet metal component, as discussed above, is depicted through two curves, namely curve 302, and curve 304 in the graphical representation 300. Curve 302 represents the thermal history of the hottest location on the assembly of the sheet metal components, whereas the curve 304 represents the thermal history of the coldest location on the assembly, both logged by the data logging device 100, clamped over the assembly of the sheet metal components. Particularly, both the curves 302 and 304 correspond to the Y-axis, disposed on the left hand side, depicting temperature of the bake oven, and the X-axis, depicting time.

More particularly, an entry line 314 depicts an entry of the assembly into the bake oven, and an exit line 316 depicts an exit of the assembly from the bake oven. The thermal history of the assembly is understood through the behaviour of the curves 302 and 304, noted before the entry to the bake oven, while travelling within the bake oven, inbetween the entry and the exit line 314 and 316, respectively, and after the exit of the assembly from the bake oven. Accordingly, a small flat profile of both the curves 302 and 304, exhibited before the entry into the bake oven, and depicted before the entry line 314 in the graphical representation 300, depicts a stable temperature behaviour of the assembly. After the entry into the oven, the oven temperatures being higher than the ambient temperatures, cause the curves 302 and 304 to slope upwards, depicting a rise in temperature, as the time spent by the assembly in the oven increases. After an exit, depicted through the line 316, both the curves 302 and 304 fall, exhibiting the temperatures at the coldest and the hottest location, dropping down to an ambient temperature.

Further, curves 306, 306′, 308, and 308′ correspond primarily to the Y-axis, disposed on the right hand side, depicting predicted degree of cure of the adhesives applied, and the X-axis, depicting time. The relationship of these curves to the temperature of the bake oven, as depicted on the Y-axis, disposed on the left hand side, will be understood through the forthcoming disclosure.

Curve 306 depicts a cure rate profile according to the predicted degree of cure (depicted on the right hand Y-axis) for an adhesive A, at the hottest location on the sheet metal component, and relationally, curve 306′ represents a cure rate profile for the degree of adhesive cure for the same adhesive A at the coldest location on the assembly of sheet metal components.

Correspondingly, curve 308 represents the cure rate profile according to the predicted degree of cure (depicted on the right hand Y-axis) for adhesive B at the hottest location on the sheet metal component. Relationally, curve 308′ represents the cure rate profile for the same adhesive B at the coldest location on the assembly of sheet metal components.

The cure profiles for the adhesives A and B, as discussed above, can be understood to be cure profiles of adhesives that are widely applied in the sheet metal industry for bonding two or more components together.

The co-relationship between the cure profiles for the two adhesives with the profile for the coldest and hottest locations on the sheet metal, in relation to time, can be understood through an example. Accordingly, cure observed for the adhesive A at the hottest location on the assembly of sheet metal components, represented by the curve 306 in FIG. 3, when applied between at least two sheet metal components, and is made to pass through the bake oven, starts curing roughly by the 12^{th} minute into the heating process. Lines 310 and 312 have been shown in order to aid in understanding the disclosed relationship. Further, a rapid cure rate is subsequently noticed within the next 2-3 minutes, attaining roughly 85% cure by the 15^{th} minute, shown through the intersection between the curve 306 and the line 310, and roughly 99% cure by the 20^{th} minute, shown according to the intersection between curve 306 and the line 312. More particularly, at the 15^{th} minute when the adhesive A reaches roughly 85% of cure, it will be understood that the temperature of the hottest location on the sheet metal component, will be roughly at 180° C., shown through the intersection of the curve 302 and the line 310. On the other hand the temperature at coldest location will be roughly 110° C., shown through the intersection between the curve 304 and line 310.

Correspondingly, the curve 308, depicting the cure profile for an adhesive B at the hottest location on an assembly of sheet metals, differs slightly from the cure profile of adhesive A, depicted through curve 306. This difference is understood through a variation attained in the profile of the curve 308, from the curve 306, as shown in the graphical representation 300.

Similarly, through the profile for the coldest location on the assembly, depicted through the curve 304, it can be observed that the predicted degree of cure differs between the two adhesives noted above. As shown, for the coldest locations on the assembly, adhesive A reaches an approximate 99% cure, depicted through curve 306′, at the end of the bake cycle, in relation to only an approximate 93% cure attained by adhesive B, depicted through the curve 308′. This difference can be explained by the different reaction kinetics of the two adhesives.

It will be understood that the relation of the curve 306 to the curves 302 and 304, as discussed above, will remain similar all throughout the graphical representation 300, for the curves 306′, 308, and 308′ as well.

Conventional data logging systems restricts users by providing them with only curves 302 and 304. An extent of adhesive cure used to be conventionally calculated by downloading this graphical data from a bulky and rarely used data logger, into a computing machine, for example a computer, laptop workstation, etc., configured on a shop floor or in a work area. Particularly, such downloading would only have been possible once the component, on to which the device 100 is mounted, has already exited the bake oven's heating process.

In an embodiment according to the present disclosure, the device 100 can be configured to transmit the degree of cure wirelessly, while being employed within the bake oven, around an assembly of sheet metal components, to a receiver. Such transmission could thus be used for automated data-collection and traceability, and could also be used to provide an end of cure signal and release of a component assembly from the bake oven.

In relation to the conventional system, the device 100 provides benefits to the process of checking and monitoring an extent of adhesive cure between two components by integrating multiple functionalities in a single, portable apparatus. The device 100 particularly enables the computation of an extent of cure through an integration algorithm, running on a kinetic model, installed within the device 100 itself. Such a configuration enables the device 100 to function more often on a conventional shop-floor, making the process of adhesive application and cure more robust.

It will be understood that adhesives applied even on components, being other than conventional sheet metals, could also employ the data logging device 100 to monitor an extent of cure, as discussed in the present disclosure. Such components could be formed of high grade plastic, alloys, etc.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A device for monitoring an extent of cure of an adhesive located between at least two components, the device comprising:
a data logger operably connected to at least one of the components, and configured to record data related to time and temperature, and to obtain a corresponding thermal history data, of the component during a heating process;
an algorithm installed in the data logger to process the thermal history data of the component, the algorithm including:
a kinetic cure model to calculate and predict the extent of adhesive cure according to the processed thermal history; and
a visual display operably connected to the data logger and configured to indicate the extent of adhesive cure.

2. The device of claim 1, wherein the device further includes a temperature probe in contact with the component, to read the component's surface temperatures, the temperature probe being connected to the data logger.

3. The device of claim 2, wherein the temperature probe is part of a clamp, the clamp configured to clamp the data logger to a region on the component.

4. The device of claim 3, wherein the clamp is a c-clamp.

5. The device of claim 1, wherein the component is a sheet metal.

6. The device of claim 1 further comprising a thermal insulation layer to protect the data logger from high temperatures during the heating process.

7. The device of claim 6, wherein the thermal insulation layer includes a quartz glass rod that provides visibility to the visual display through the insulation layer.

8. The device of claim 1, wherein the visual display is a light emitting diode.

9. A device for monitoring adhesive cures between at least two sheet metal components, the device comprising:
a c-clamp for clamping onto at least one of the sheet metal components, the c-clamp configured to include a temperature probe to read the sheet metal component's surface temperatures;
a data logger, connected to the temperature probe, configured to record data related to the temperature and time, and to obtain a corresponding thermal history data of the sheet metal component during a heating process, the data logger including:
an algorithm to process the thermal history data of the sheet metal component, the algorithm including:
a kinetic cure model to calculate and predict an extent of adhesive cure according to the processed thermal history;
a light emitting diode operably connected to the data logger, configured to indicate the extent of adhesive cure; and
a thermal insulation layer to protect the device from high temperatures during the heating process, the thermal insulation layer including a quartz glass rod to provide visibility to the light emitting diode through the thermal insulation layer.

10. A device to monitor cures in adhesive applied between at least two sheet metal components, the device comprising:
a clamp configured to clamp the device onto at least one of the sheet metal components;
a data logger configured to record data related to temperature and time, and to obtain a corresponding thermal history data of the sheet metal component to which the device is clamped onto, during a heating process, the data logger including:
an algorithm to process the thermal history data of the sheet metal component, the algorithm including:
a kinetic cure model to calculate and predict an extent of adhesive cure according to the processed thermal history;
a light emitting diode operably connected to the data logger, configured to indicate the extent of adhesive cure; and
a thermal insulation layer to protect the device from high temperatures during the heating process.

11. The device of claim 10, wherein the clamp is a c-clamp, and is configured to include a temperature probe to read the sheet metal component's surface temperatures.

12. The device of claim 11, wherein the temperature probe is operably connected to the data logger.

13. The device of claim 11, wherein the thermal insulation layer includes a quartz glass rod to provide visibility to the light emitting diode through the thermal insulation layer.
